(19) United States
(12) Patent Application Publication
(10) Pub. No.: US 2024/0246407 A1
(43) Pub. Date: Jul. 25, 2024

(54) MOTOR UNIT

(71) Applicant: TOYOTA JIDOSHA KABUSHIKI KAISHA, Toyota-shi (JP)

(72) Inventors: Keita IMAI, Seto-shi (JP); Kiichi YOKOYAMA, Toyota-shi (JP); Hiroki MONJI, Toyota-shi (JP); Yusuke UETA, Shizuoka-ken (JP); Tatsuya SAKAI, Toyota-shi (JP)

(73) Assignee: TOYOTA JIDOSHA KABUSHIKI KAISHA, Toyota-shi (JP)

(21) Appl. No.: 18/541,390

(22) Filed: Dec. 15, 2023

(30) Foreign Application Priority Data
Jan. 20, 2023 (JP) 2023-007282

(51) Int. Cl. B60K 7/00; B60K 17/04; F16H 1/06; F16H 57/021

(52) U.S. Cl. CPC B60K 7/0007; B60K 17/043; F16H 1/06; F16H 57/021; B60K 2007/0061; F16H 2057/02034

(57) ABSTRACT

A motor unit includes a first rotating shaft driven by a motor and including a first gear, a pair of first bearings, each of which is located on each side of the first gear, and that supports the first rotating shaft to the casing such that the first rotating shaft is rotatable, a second rotating shaft being parallel to the first rotating shaft and including a second gear meshing with the first gear, and a pair of second bearings, each of which is located on each side of the second gear, and that supports the second rotating shaft to the casing such that the second rotating shaft is rotatable. The second bearings are located between the first bearings in an axial direction parallel to the first rotating shaft and the second rotating shaft, and each of the second bearings includes an outer ring, an inner ring, and a rolling element.

### CROSS-REFERENCE TO RELATED APPLICATION

This application claims priority to Japanese Patent Application No. 2023-007282 filed on Jan. 20, 2023, incorporated herein by reference in its entirety.

### BACKGROUND

### 1. Technical Field

A technique disclosed in the present specification relates to a motor unit. In particular, the technique relates to an in-wheel motor unit that drives a wheel of a vehicle.

### 2. Description of Related Art

An in-wheel motor drive device disclosed in Japanese Unexamined Patent Application Publication No. 2018-063019 (JP 2018-063019 A) includes a casing, an input shaft driven by an electric motor and including an input gear, and an intermediate shaft that is parallel to the input shaft and includes an input intermediate gear that meshes with the input gear. A bearing that supports the input shaft with respect to the casing and a bearing that supports the intermediate shaft with respect to the casing are provided between the input shaft and the intermediate shaft.

### SUMMARY

The bearing supports the outer peripheral surface of the rotating shaft with respect to the casing such that the rotating shaft is rotatable. Also, the two rotating shafts having gears that mesh with each other are offset in the radial direction of the rotating shafts.

Between these two shafts, two bearings that support the respective rotating shafts with respect to the casing such that the rotating shafts are rotatable, and a casing that supports the bearings are arranged so as to overlap in the radial direction of the shafts. Further, a load caused by the rotation of the rotating shaft is applied to the casing that supports the bearings. Therefore, the casing is required to have rigidity that can withstand the load. Therefore, it becomes difficult to extremely reduce the radial height of the casing. In this way, in the in-wheel motor unit in which the two rotating shafts are arranged so as to be offset, the layout of the bearings and the casing is complicated. These layouts increase the size of the casing. The present specification provides a technique that can improve the degree of freedom in the layout of the bearings and the casing.

The present specification discloses an in-wheel motor unit that drives a wheel of a vehicle.

The motor unit includes:
a motor;
a casing that accommodates the motor;
a first rotating shaft that is driven by the motor and includes a first gear;
a pair of first bearings, each of which is located on each side of the first gear, and that supports the first rotating shaft with respect to the casing such that the first rotating shaft is rotatable;
a second rotating shaft that is parallel to the first rotating shaft and includes a second gear meshing with the first gear; and
a pair of second bearings, each of which is located on each side of the second gear, and that supports the second rotating shaft with respect to the casing such that the second rotating shaft is rotatable, in which:
the second bearings are located between the first bearings in an axial direction parallel to the first rotating shaft and the second rotating shaft; and
each of the second bearings includes an outer ring fixed to the second gear from a radially inner side, an inner ring fixed to the casing from a radially outer side, and a rolling element located between the outer ring and the inner ring.

In the motor unit described above, each of the second bearings supports the second gear with respect to the casing from the radially inner side such that the second gear is rotatable. Therefore, for example, compared to a configuration in which the casing is interposed between the second gear and the second bearings, the degree of freedom in layout of the second bearings can be improved.

Details of the techniques disclosed in the present specification and further modifications will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a side view of a motor unit 10 of an embodiment;

FIG. 2 shows a cross-sectional view along line II-II of FIG. 1;

FIG. 3 shows an enlarged view of the area bounded by line III of FIG. 2; and

FIG. 4 shows an enlarged view of the area enclosed by line IV in FIG. 3.

### DETAILED DESCRIPTION OF EMBODIMENTS

In an embodiment of the present technology, both end surfaces of the second gear in the axial direction may be provided with grooves that respectively accommodate the pair of second bearings. In that case, the outer ring of the second bearing may be fixed to the inner peripheral surface of the groove from the radially inner side. With such a configuration, the second bearing is at least partially accommodated in the groove, so that the axial size of the casing can be reduced.

In an embodiment of the present technology, the casing may be provided with a pair of bosses projecting toward respective grooves of the second gear. In that case, the inner ring of the second bearing may be fixed to the outer peripheral surface of the boss from the radially outer side. According to such a configuration, the portion accommodated in the groove of the second bearing can be stably supported by the boss of the casing.

In an embodiment of the present technology, the pair of first bearings and the pair of second bearings may at least partially overlap when viewed along the axial direction. With such a configuration, the distance between the first rotating shaft and the second rotating shaft can be reduced.

In an embodiment of the present technology, the first rotating shaft may be coaxially connected to the motor and the second rotating shaft may be coaxially connected to the wheel. However, in other embodiments, for example, the second rotating shaft may be arranged radially offset with respect to the wheels. In that case, the second gear may mesh with a third gear provided on a third rotating shaft coaxially arranged with respect to the wheel.

### EXAMPLE

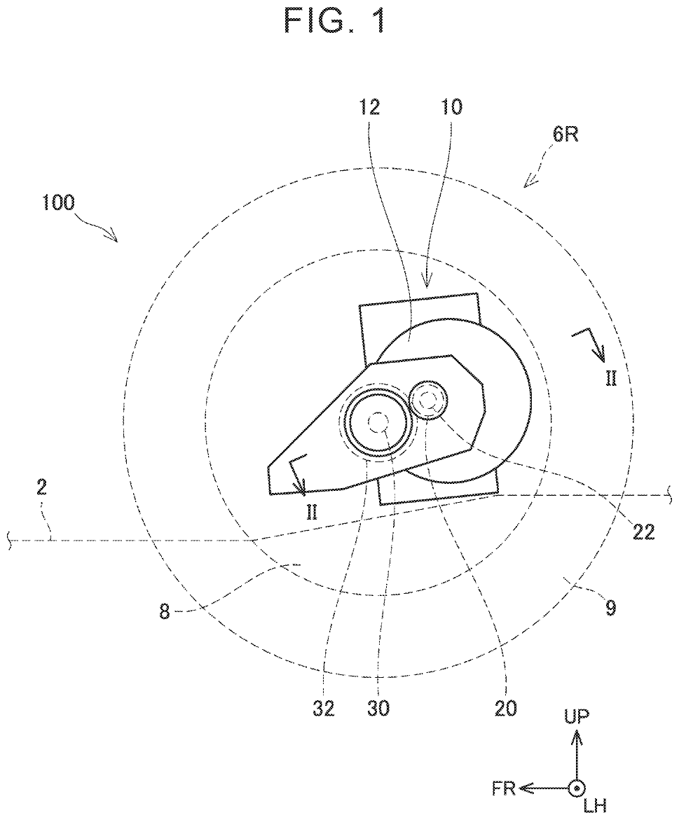

FIG. 1 shows a side view of a motor unit 10 of an embodiment. The motor unit 10 is provided on the rear wheel 6R of the electrified vehicle 100. The electrified vehicle 100 drives the rear wheels 6R by supplying electric power from a battery (not shown) to an in-wheel motor unit 10 provided on the rear wheels 6R. The electrified vehicle 100 herein includes battery electric vehicles as well as fuel cell electric vehicles. In the coordinate system in the drawing, FR indicates the front of the electrified vehicle 100, UP indicates the upper side of the electrified vehicle 100, and LH indicates the left side of the electrified vehicle 100. In the following, “top”, “bottom”, “left”, “right”, “front” and “back” are described based on the coordinate system in the drawing.

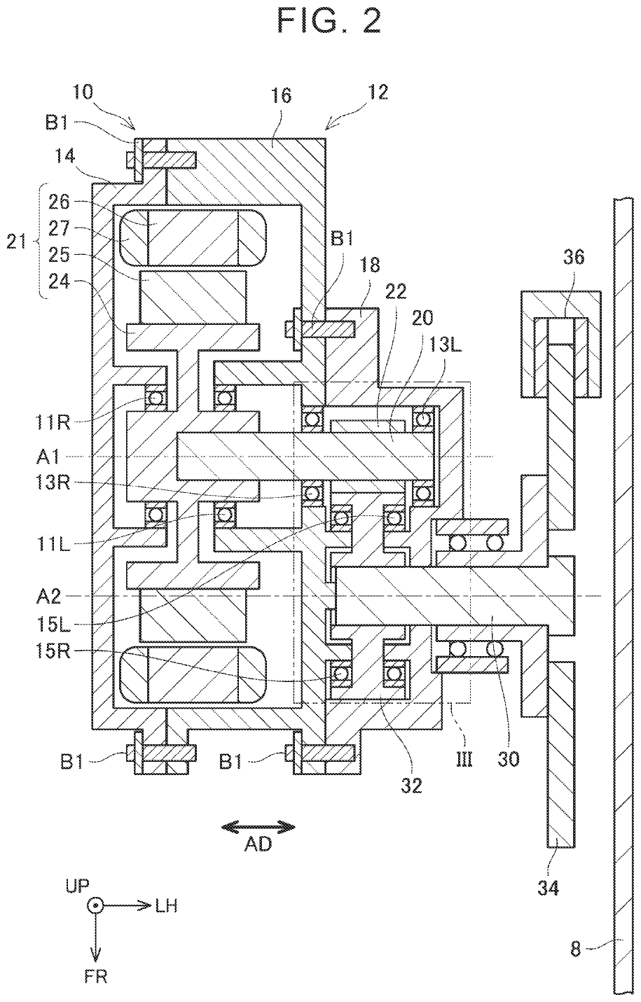

Although not shown, the motor unit 10 is connected to the vehicle body 2 of the electrified vehicle 100 by a trailing arm without a rear suspension. Further, although the details will be described later with reference to FIG. 2, the motor unit 10 is directly connected to the rear wheel 6R without a rear suspension. The rear wheel 6R includes wheels 8 and tires 9. The wheel 8 covers the motor unit 10 from the outside of the vehicle (that is, the front side of the paper surface of FIG. 1).

As shown in FIG. 2, the motor unit 10 includes a motor 21, an input shaft 20, an output shaft 30, and a casing 12. The motor 21 is a so-called radial gap motor. The motor 21 includes a rotor 24, a rotor core 25, stator coils 26 and a stator core 27. The rotor core 25 is provided on the outer peripheral surface of the rotor 24. The stator coil 26 is wound around the outer peripheral surface of the stator core 27. The stator coil 26 and the stator core 27 face the rotor core 25 from the outside in the radial direction of the rotor core 25 (that is, the vertical direction of the paper surface of FIG. 2). Both the rotor core 25 and the stator core 27 are made of a magnetic material. A magnetic force is generated between the rotor core 25 and the stator coil 26 by the current flowing through the stator coil 26, and the rotor 24 rotates.

The input shaft 20 is inserted into the radially central portion of the rotor 24. Input shaft 20 has a cylindrical shape extending in the left-right direction. The input shaft 20 is arranged coaxially with the central axis A1 of the rotor 24. That is, the input shaft 20 is provided coaxially with the motor 21. Rotational motion of the rotor 24 of the motor 21 is transmitted to the input shaft 20. That is, the input shaft 20 is driven by the motor 21.

An input gear 22 is provided at the left end of the input shaft 20 (that is, the right end of the paper surface of FIG. 2). The input gear 22 rotates together with the input shaft 20. An output gear 32 is positioned in front of the input gear 22 (that is, below the paper surface of FIG. 2). The input gear 22 and the output gear 32 are in mesh with each other.

The output gear 32 is fixed to the outer peripheral surface of the output shaft 30. Rotation of the rotor 24 of the motor 21 is thereby transmitted to the output shaft 30 via the input shaft 20. The output shaft 30 has a columnar shape extending in the left-right direction. That is, the output shaft 30 extends parallel to the input shaft 20. A central axis A1 of the rotor 24 and a central axis A2 of the output shaft 30 extend parallel to each other. That is, the input shaft 20 and the output shaft 30 extend in the axial direction AD parallel to both shafts 20,30.

Casing 12 houses motor 21, input gear 22, and output gear 32. Casing 12 includes a first casing 14, a second casing 16 and a third casing 18. Each casing 14, 16, 18 overlaps in the left-right direction. The first casing 14 located on the innermost side of the vehicle (that is, the left side of the paper surface of FIG. 2) supports the motor 21 from the inner side of the vehicle. A bearing 11R is provided between the rotor 24 of the motor 21 and the first casing 14.

The second casing 16 covers the motor 21 from the outside of the vehicle (that is, the right side of the paper surface of FIG. 2). The first casing 14 and the second casing 16 are fastened with a plurality of bolts B1. A bearing 11L is provided between the input shaft 20 and the second casing 16. Thus, the first casing 14 and the second casing 16 of the casing 12 rotatably support the motor 21 by a pair of bearings 11R, 11L provided on both sides of the rotor 24 in the axial direction AD.

The input shaft 20 extends outside the vehicle through the outer wall of the second casing 16. The tip of the input shaft 20 and the input gear 22 are covered with the third casing 18 from the outside of the vehicle. The second casing 16 and the third casing 18 are fastened with a plurality of bolts B1. A bearing 13L is provided between the tip of the input shaft 20 and the third casing 18. Similarly, a bearing 13R is provided between the input shaft 20 and the second casing 16 on the right side of the input gear 22 of the input shaft 20 (that is, on the left side of the paper surface of FIG. 2). Thus, the second casing 16 and the third casing 18 of the casing 12 rotatably support the input shaft 20 by a pair of bearings 13R, 13L provided on both sides of the input gear 22 in the axial direction AD.

The output gear 32 is positioned between the second casing 16 and the third casing 18. A pair of bearings 15R and 15L is provided on both sides of the output gear 32 in the axial direction AD. The output shaft 30 extends outside the vehicle through the outer wall of the third casing 18. A disc rotor 34 is provided at the tip of the output shaft 30. The disc rotor 34 has a disk shape and rotates together with the output shaft 30. A brake piston 36 is provided behind the disc rotor 34 (that is, above the plane of FIG. 2). The brake piston 36 stops the rotation of the output shaft 30 by pinching the disc rotor 34.

The tip of the output shaft 30 is covered with the wheel 5 from the outside of the vehicle. Thus, the output shaft 30 is coaxially connected to the rear wheel 6R. The second casing 16 and the third casing 18 thus support the output shaft 30. In addition, in the modified example, the structure of the casing 12 is not limited to the structure divided into the respective casings 14, 16, 18, and an integrated structure may be adopted.

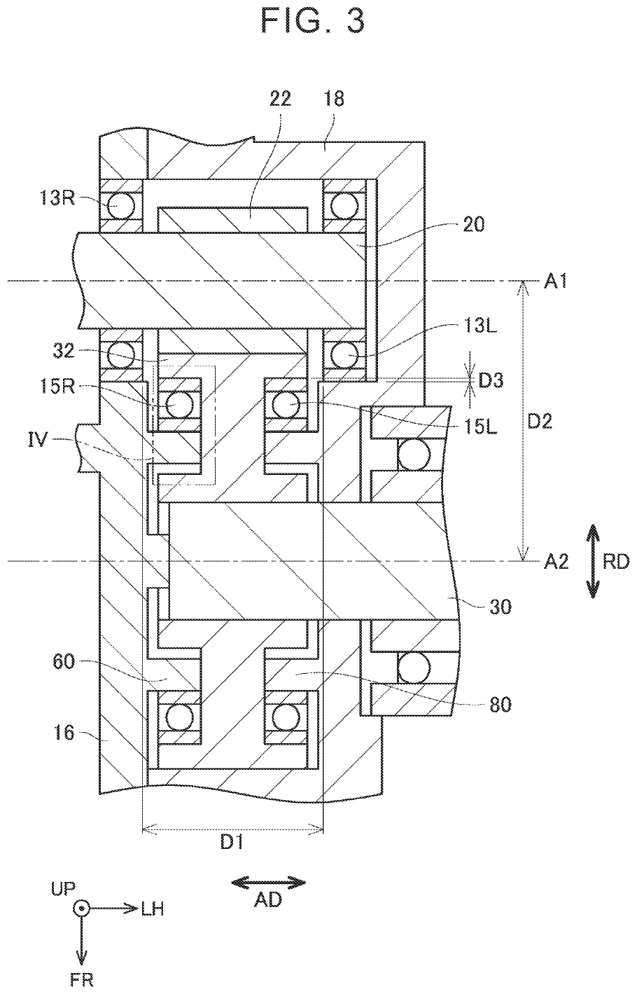

The positional relationship between the pair of bearings 13R, 13L and the pair of bearings 15R, 15L in the motor unit 10 of this embodiment will be described with reference to FIG. 3. With respect to the axial direction AD, the distance between both ends of the pair of bearings 15R, 15L is shorter than the distance D1 between the pair of bearings 13R, 13L. In other words, the pair of bearings 15R and 15L are positioned between the pair of bearings 13R and 13L with respect to the axial direction AD. For example, in a configuration in which the pair of bearings 13R and 13L and the pair of bearings 15R and 15L partly overlap when viewed along the radial direction RD of the output shaft 30, it is necessary for the casing 12 to interpose a boss to support both of the bearings 13R and 13L and the bearings 15R and 15L. In such a configuration, the distance D2 between the central axis A1 of the input shaft 20 and the central axis A2 of the output shaft 30 is long.

Further, in this case, a load is applied to the bosses of the casing 12 supporting both of the casing 12 via the pair of bearings 13R, 13L and the pair of bearings 15R and 15L from both sides in the radial direction RD as the input shaft 20 and the output shaft 30 rotate. For this reason, the boss of the casing 12 is required to have higher rigidity than a configuration in which a load is applied from one side in the radial direction RD. As a result, as for the radial direction RD, the boss is higher in the radial direction RD than the boss of the casing 12 that does not support the pair of bearings 13R, 13L and the pair of bearings 15R, 15L. Therefore, the distance D2 between the central axis A1 of the input shaft 20 and the central axis A2 of the output shaft 30 tends to become longer.

In the motor unit 10 of this embodiment, the pair of bearings 15R and 15L are positioned between the pair of bearings 13R and 13L with respect to the axial direction AD. For this reason, it is not necessary to interpose the boss of the casing 12 between them. As a result, the degree of freedom in layout of the pair of bearings 15R and 15L with respect to the pair of bearings 13R and 13L can be improved.

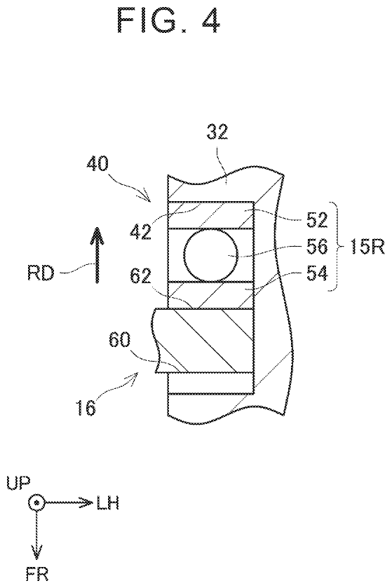

A detailed structure of the pair of bearings 15R and 15L will be described with reference to FIG. 4. Of the pair of bearings 15R and 15L, the structure of the bearing 15R located on the right side (that is, the left side of the paper surface of FIG. 2) will be mainly described in this specification. However, bearings 11R, 11L, 13R, 13L, and 15L have similar configurations.

The bearing 15R is a so-called radial ball bearing. The bearing 15R extends annularly along the circumferential direction of the output gear 32. The bearing 15R includes an outer ring 52, an inner ring 54, and rolling elements 56. The outer ring 52 is located outside the rolling element 56 in the radial direction RD. The inner ring 54 is located inside the rolling element 56 in the radial direction RD. The outer ring 52 and the inner ring 54 support the rolling elements 56 slidably along the circumferential direction of the output gear 32.

A groove 40 is provided in the right end face of the output gear 32. The groove 40 is a depression extending annularly along the circumferential direction of the output gear 32. The groove 40 accommodates the bearing 15R and the boss 60 of the second casing 16. The boss 60 is a projection extending annularly along the circumferential direction of the output gear 32. The boss 60 has a rectangular cross-section and faces the inner surface of the inner peripheral surface 42 of the groove 40 in the radial direction RD (that is, the lower side of the paper surface of FIG. 2) with a gap therebetween.

As shown in FIG. 4, the bearing 15R is positioned between the outer surface in the radial direction RD of the inner peripheral surface 42 of the groove 40 and the outer peripheral surface 62 of the boss 60. That is, the bearing 15R is housed in the groove 40. More specifically, the outer ring 52 of the bearing 15R is fixed to the inner peripheral surface 42 of the groove 40 from the inside in the radial direction RD (that is, the lower side of the paper surface of FIG. 4), and the inner ring 54 of the bearing 15R is fixed to the outer peripheral surface 62 of the boss 60 from the outside in the radial direction RD. Similarly, of the pair of bearings 15R and 15L, the outer ring 52 of the left bearing 15L positioned at the left side is also fixed to the inner peripheral surface 42 of the groove 40 from the inside in the radial direction RD, and the inner ring 54 of the bearing 15L is fixed to a boss 80 of the third casing 18 (see FIG. 3) from the outside in the radial direction RD. Thus, the output gear 32 is rotatably supported with respect to the casing 12. By housing the bearing 15R in the groove 40, the distance between the pair of bearings 15R and 15L can be shortened. As a result, the size of the casing 12 can be reduced with respect to the axial direction AD.

Thus, in the motor unit 10 of this embodiment, the bosses 60 and 80 of the casing 12 are not interposed between the pair of bearings 15R and 15L and the outer surface of the inner peripheral surface 42 of the output gear 32 in the radial direction RD. Therefore, the pair of bearings 15R and 15L can be brought closer to the input shaft 20. Furthermore, as shown in FIG. 3, in the motor unit 10, the rear ends of the pair of bearings 15R and 15L (that is, the ends on the upper side of the paper surface of FIG. 3) are arranged behind the front ends of the pair of bearings 13R and 13L. That is, when viewed along the axial direction AD, the rear ends of the pair of bearings 15R and 15L overlap the front ends of the pair of bearings 13R and 13L by a distance D3. In other words, the distance D2 between the central axis A1 of the input shaft 20 and the central axis A2 of the output shaft 30 is shorter, by the distance D3, than the distance obtained by adding up the distance between the central axis A1 and the front ends of the pair of bearings 13R and 13L and the distance between the central axis A2 and the rear ends of the pair of bearings 15R and 15L. Thus, the motor unit 10 of this embodiment can reduce the size of the casing 12 particularly in the radial direction RD by improving the degree of freedom in layout of the pair of bearings 15R and 15L.

### Correspondence

The input gear 22 is an example of a “first gear”, and the output gear 32 is an example of a “second gear”. The input shaft 20 is an example of a “first rotating shaft”, and the output shaft 30 is an example of a “second gear”. The pair of bearings 13R, 13L is an example of “a pair of first bearings”, and the pair of bearings 15R, 15L is an example of “a pair of second bearings”.

Although the specific examples disclosed by the present disclosure have been described in detail above, these are merely examples and do not limit the scope of claims. The techniques described in the claims include various modifications and alternations of the specific example illustrated above. Modifications of the above-described embodiment are listed below.

### First Modified Example

In the motor unit 10 of this embodiment, the entire range of the bearing 15R is accommodated in the groove 40 of the output gear 32 with respect to the axial direction AD. However, in a variant, for example, half of the bearing 15R may be housed in the groove 40 with respect to the axial direction AD. Generally speaking, it is sufficient that the bearing 15R is partially accommodated in the groove 40.

### Second Modified Example

Output gear 32 may not include groove 40. In that case, the outer ring 52 of the bearing 15R may be fixed from the inside in the radial direction RD to the projection provided on the right end face of the output gear 32 in the axial direction AD.

### Third Modification

The casing 12 may not have the bosses 60,80. In that case, for example, the inner ring 54 of the bearing 15R may be fixed to the casing 12 in the axial direction AD.

### Fourth Modification

An intermediate gear may be provided between the input gear 22 and the output gear 32. In that case, for example, a pair of intermediate bearings that rotatably support the intermediate gear on the casing 12 may be positioned between the pair of bearings 13R and 13L with respect to the axial direction AD. Further, each of the pair of intermediate bearings may have an outer ring 52 fixed radially inwardly to the intermediate gear, an inner ring 54 fixed radially outwardly to the casing 12, and rolling elements 56. In this modified example, the intermediate gear is an example of the “second gear”, and the intermediate bearing is an example of the “second bearing”.

The technical elements described in the present specification or drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. An in-wheel motor unit that drives a wheel of a vehicle, the in-wheel motor unit comprising:
a motor;
a casing that accommodates the motor;
a first rotating shaft that is driven by the motor and includes a first gear;
a pair of first bearings, each of which is located on each side of the first gear, and that supports the first rotating shaft with respect to the casing such that the first rotating shaft is rotatable;
a second rotating shaft that is parallel to the first rotating shaft and includes a second gear meshing with the first gear; and
a pair of second bearings, each of which is located on each side of the second gear, and that supports the second rotating shaft with respect to the casing such that the second rotating shaft is rotatable, wherein:
the second bearings are located between the first bearings in an axial direction parallel to the first rotating shaft and the second rotating shaft; and
each of the second bearings includes an outer ring fixed to the second gear from a radially inner side, an inner ring fixed to the casing from a radially outer side, and a rolling element located between the outer ring and the inner ring.

2. The motor unit according to claim 1, wherein:
each end face in the axial direction of the second gear is provided with a groove for accommodating each of the second bearings; and
the outer ring of each of the second bearings is fixed to an inner peripheral surface of the groove from the radially inner side.

3. The motor unit according to claim 2, wherein:
the casing is provided with a pair of bosses, each of which projects toward each groove of the second gear; and
the inner ring of each of the second bearings is fixed to an outer peripheral surface of the boss from the radially outer side.

4. The motor unit according to claim 1, wherein when viewed along the axial direction, the first bearings and the second bearings at least partially overlap.

5. The motor unit according to claim 1, wherein:
the first rotating shaft is coaxially connected to the motor; and
the second rotating shaft is coaxially connected to the wheel.
